(19) United States
(12) Patent Application Publication
(10) Pub. No.: US 2004/0244270 A1
(43) Pub. Date: Dec. 9, 2004

(54) Planar device for directional trolling

(76) Inventors: Kevin John Brinker, Clarkston, MI (US); Holly Jean Moore, Clarkston, MI (US)

Correspondence Address: DICKINSON WRIGHT PLLC, 1901 L. STREET NW, SUITE 800, WASHINGTON, DC, 20036, US

(21) Appl. No.: 10/790,998

(22) Filed: Mar. 2, 2004

Related U.S. Application Data
(63) Continuation-in-part of application No. 10/439,380, filed on May 19, 2003, now abandoned.

(51) Int. Cl. A01K 91/00

(52) U.S. Cl. 43/43.13

(57) ABSTRACT

A planar device for directional trolling is disclosed. The device comprises a planar, disk-shaped body, a quick release assembly for the quick release of a fishing line, the quick release assembly including a quick release arm that is pivotally attached to the planar, disk-shaped body, and a line locking assembly for securing a portion of a fishing line to the planar, disk-shaped body. A portion of the fishing line is secured to the planar body by the line locking assembly in the form of a spring and guide assembly in which the guide holds the fishing line and the spring holds the guide to the planar body.

### FIELD OF THE INVENTION

The present invention relates to fishing devices for use while trolling. More particularly, the present invention relates to a planar device for directional trolling that comprises a planar body, an element for the quick release of a fishing line pivotally attached to the planar body, and a line locking assembly for securing a portion of a fishing line to the planar body.

### DESCRIPTION OF THE PRIOR ART

In the sport of fishing there are many approaches to movement of the fishing line and its accompanying lure and bait used to attract fish. Movement of the line is typically accomplished by pulling the lure and bait combination through the water either by moving the fishing shaft and reel while essentially standing still or by the pulling of the lure and bait by movement of a trolling fishing boat. In either approach, it is important that the lure and bait be positioned at a selected depth in an effort to hook fish in that area. This is not always an easy task given the varieties of lures and baits and their different weights. For example, when trolling at a relatively high speed in a boat, there is a tendency for the lure and bait to remain close to the surface rather than dropping to a desired depth.

In order to overcome this inherent restriction to the simple lure and bait combination, the use of a trolling device in the form of a planar board has generally been adopted by some in trolling. Examples may be found in U.S. Pat. Nos. 3,940,872, 5,339,561, 5,867,932, 5,867,933 and 6,016,622, set forth hereafter.

With respect to U.S. Pat. No. 3,940,872, issued on Mar. 2, 1976, to Weber for FISHING DEVICE, a flat, semi-disk-shaped plate with a connection for fishing bait and a fishing line is disclosed. An upstanding fin extends from one side of the plate.

With respect to U.S. Pat. No. 5,339,561, issued on Aug. 23, 1994, to Weber for DIRECTIONAL DIVING DEVICE FOR TROLLING, a diving sinker having a planing member with a fin formed on the top surface of the planing member is disclosed. On the underside of the planing member is a chamber which increases the volume and buoyancy of the diver.

With respect to U.S. Pat. No. 5,867,932, issued on Feb. 9, 1999, to Reiger for TROLLING OUTRIGGER, a trolling device for trolling a fishing lure from a moving boat is disclosed. The device includes a sealed floating hull with a counter-steering rudder, multiple line release clasps, and a variable depth measuring device.

With respect to U.S. Pat. No. 5,867,933, also issued Feb. 9, 1999, to Walker for PLANAR BOARD WITH STRIKE INDICATOR, a relatively complex planar board with strike indicator is disclosed. The planar board includes a base, a light source, a tip-up assembly, an actuation assembly, and a switch. When the lure is struck by a fish, the actuating fishing line release pivots away from the front fishing line release, whereby the pole is released to display a flag, and the light is activated.

With respect to U.S. Pat. No. 6,016,622, issued Jan. 25, 2000, to Even for FISHING DIVER WITH SLIDE THROUGH LINE AND PROTECTIVE FLEXIBLE SLEEVE THEREFOR, a fishing diver is provided by a diving planer. The planer includes a latch member for clamping the diving plane to the fishing line. When used in trolling, the diver dives downwardly and, when struck by a fish, the diving plane is unclamped.

While representing certain improvements in the state of the art for trolling, modifications and improvements can yet be made in the design of trolling devices.

### SUMMARY OF THE INVENTION

The present invention overcomes the limitations of the prior art by providing a planar device for directional trolling that comprises a planar, disk-shaped body, a quick release assembly for the quick release of a fishing line, the quick release element including a quick release arm that is pivotally attached to the planar, disk-shaped body, and a fish line locking assembly for securing a portion of a fishing line to the planar, disk-shaped body. A portion of the fishing line is secured to the planar body by the fish line locking assembly that includes a spring and guide in which the guide holds the fishing line and the spring holds the guide to the planar body. The planar configuration of the present invention allows the operator to guide the bait away from the operator's position by planing and diving.

The arm of the quick release assembly includes a ball which nests within a ball receiver formed on one side of the planar, disk-shaped body. The ball is held in place by a ball receiver cover. The quick release arm includes a shaft that passes through an aperture defined in the ball receiver and through the planar, disk-shaped body to extend from the opposite side of the body as the ball receiver. A quick release clip is attached to the end of the shaft opposite the ball. The fishing line is releasably held by the quick-release clip. When a fish strikes the bait, the force of the fish movement effects a release of the line from the quick-release clip. However, the planar body is held to the line by the retaining mechanism for retrieval with the fish.

A counterweight and a float may be fitted to the planar body.

Accordingly, it is the general object of the present invention to provide a planar device for directional trolling which is simple to operate and maintain.

It is a further object of the present invention to provide such a device that readily and precisely acquires a selected depth.

Yet a further object of the present invention is to provide such a device that is inexpensive to manufacture.

Still an additional object of the present invention is to provide such a device where the need for tying knots in the fishing line is eliminated.

A further object of the present invention is to provide such a device which can be used from a boat or from any environment with a tide or a current, including off of docks and off-shore.

Further scope of the applicability of the present invention will become apparent from the following detailed description, claims and drawings. However, it should be understood that the detailed description and specific examples, while indicating preferred embodiments of the invention, are given for illustrative purposes only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a perspective, generally top view of the planar device for directional trolling of the present invention;

FIG. 2 is a perspective, generally bottom view of the device of the present invention;

FIG. 3 is a view similar to that of FIG. 1 but illustrating the fishing device in an exploded configuration;

FIG. 4 is a side view of the fishing device with the fishing line attached to the body by the line locking assembly and the quick release assembly;

FIG. 5 is a side view of the fishing device similar to that of FIG. 4, but showing the fishing line released from the quick release assembly;

FIG. 6 is a top plan view of the fishing device of the present invention showing the fishing line still captured by the line locking assembly but released from the quick release assembly;

FIG. 7 is an end view of the device of the present invention illustrating the pivoting action of the quick release arm of the quick release assembly;

FIG. 8 is an end view of a further embodiment of the present invention illustrating the addition of an optional floatation device to the body of the device;

FIG. 9 is a partial top view of the end of a boat illustrating a series of fishing shafts with trolling lines and fishing devices of the present invention connected thereto; and

FIG. 10 is an elevational environmental view illustrating the device used off-shore in conjunction with sports fishing.

### DETAILED DESCRIPTION OF THE PREFERRED EMBODIMENT

The drawings disclose the preferred embodiment of the present invention. While the configurations according to the illustrated embodiment are preferred, it is envisioned that alternate configurations of the present invention may be adopted without deviating from the invention as portrayed. The preferred embodiments are discussed hereafter.

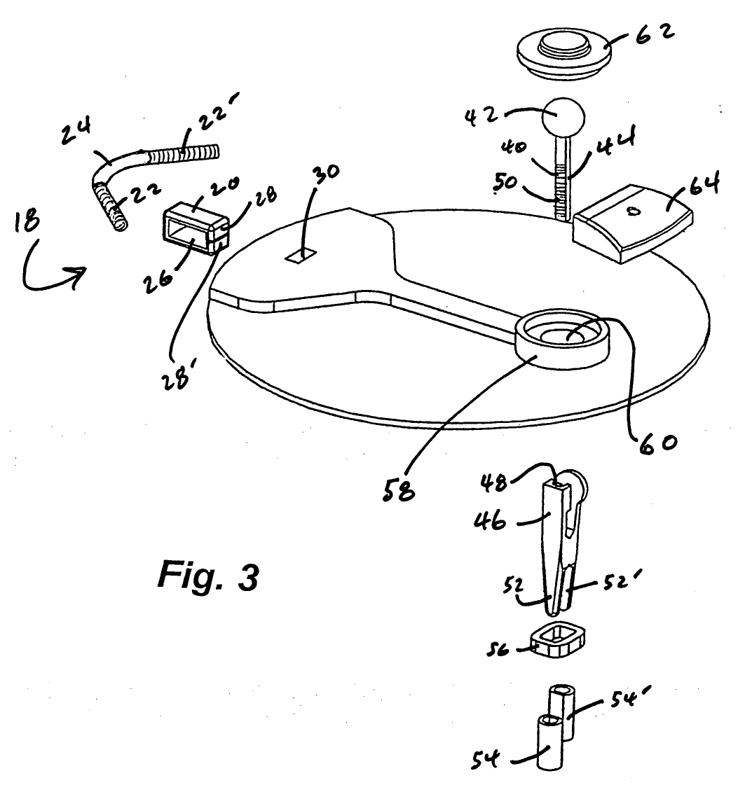

With reference to FIGS. 1, 2 and 3, various views of a fishing device according to the present invention, illustrated as 10, are shown. The components of the fishing device may be made of a variety of materials, including rubber, molded plastic components, brass/brass-plated and stainless steel elements. For example, the body of the device may be made from a molded polycarbonate. The only prerequisite for the selection of material is that the material chosen be resistant to degradation which may be caused by either salt and fresh water.

The device 10 includes a planar, disk-shaped body 12, a fishing line locking assembly, generally illustrated as 14, and a fishing line quick release assembly generally illustrated as 16. It is to be understood that while the preferred shape of the present invention is in the form of a disk, other shapes may be possible, such as an oval.

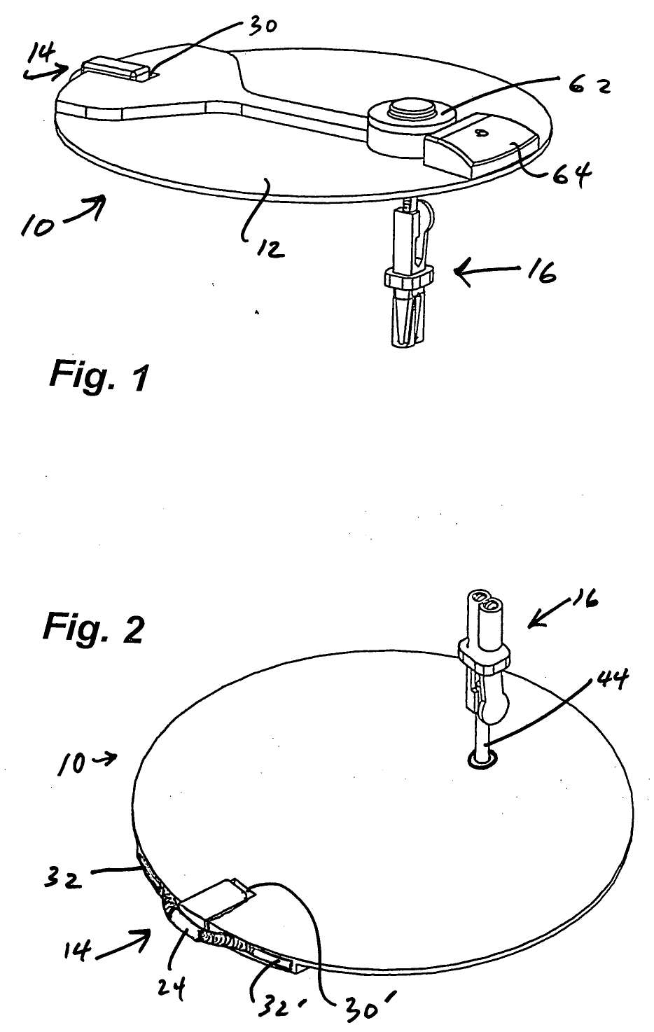

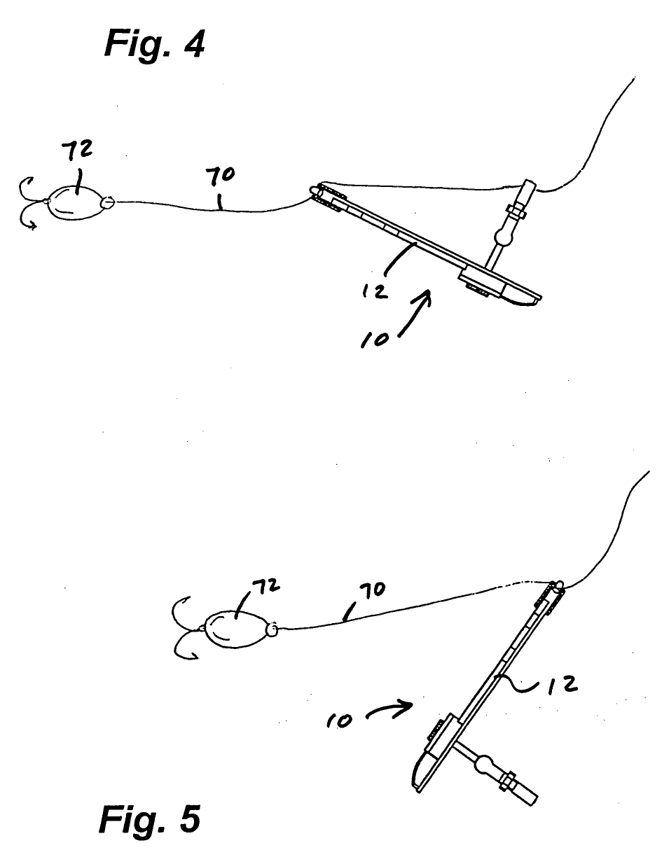

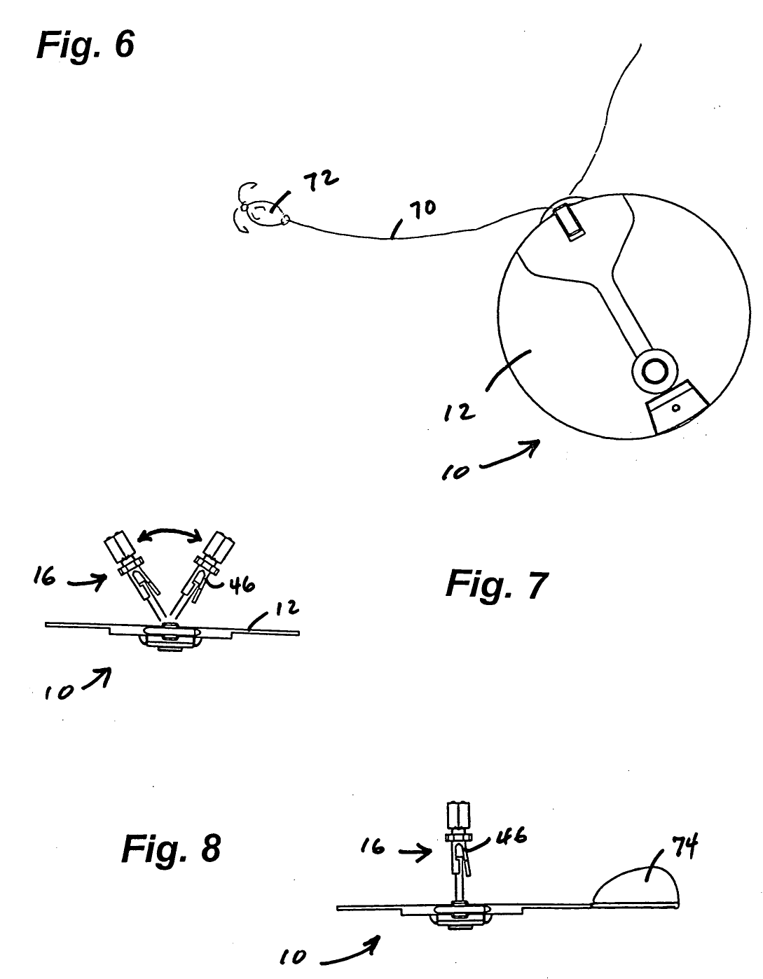

The fishing line locking assembly 14 includes a fishing line spring 18 and a guide 20. The fishing line spring 18 includes a pair of spaced-apart spring elements 22, 22′ that are connected to one another by a line insulator 24. A line guide 26 having a pair of opposed flanges 28, 28′ is releasably attached to the body 12 by attaching to a pair of slots 30 (formed on the top side of the body 12), 30′ (formed on the bottom side of the body 12). The spaced apart spring elements 22, 22′ are frictionally engaged with a pair of slots 32, 32′ formed in the end wall of the body 12, as illustrated in FIG. 2. A portion of the fishing line is captured between the insulator 24 and the line guide 26 which are formed from a rubber or a plastic material to protect the line from damage. The capture of the line between the insulator 24 and the line guide 26 is shown in FIGS. 4 through 6.

Still referring to FIGS. 1 through 3, the quick release assembly 16 comprises a quick release arm 40 which includes a ball 42 and a shaft 44. The ball 42 may be attached to the shaft 44 in a known manner such as by threading or may be integrally molded therewith. The quick release arm 40 further includes a quick release clip 46 that is attached to the shaft 44. The quick release clip 46 preferably includes a locking flange 48. As a preferred option, the shaft 44 may have formed on one side thereon a plurality of parallel ridges 50 which provide selective stops for the locking flange 48 of the clip 46, thereby allowing linear adjustment of the quick release clip 46, thereupon.

The quick release clip 46 further includes a pair of opposed jaws 52, 52′ on which are provided rubber or plastic grips 54, 54′. A resilient band 56 is placed over the opposed jaws 52, 52′ to act as a biasing element by which the jaws 52, 52′ are urged to their closed positions. A portion of the fishing line is placed between the grip-covered jaws 52, 52′ as will be discussed below.

The ball 42 is releasably disposed within a ball receiver 58 formed in the top side of the body 12. An aperture 60 is formed at the base of the ball receiver 58 thus forming a continuous opening from one side to the other. With the ball 42 in place in the ball receiver 58, the shaft 44 of the quick release arm 40 extends through the aperture 60. The ball 42 is held in place within the ball receiver 58 by a cap 62 which is held in place to the ball receiver 58 by threading or by conventional fasteners such as screws (not shown).

A weight 64 may optionally be fitted to the body 12 by fastening with conventional fasteners in a known manner. The weight 64 may be interchangeable with other weights of different amounts so as to help pull the device 10 downward to achieve a desired depth.

In operation, and generally referring to FIGS. 4 through 6, the user first draws a fishing line 70 (with a lure 72 attached at one end) between the insulator 24 and the line guide 26 of the fishing line lock assembly 14 until a desired point is reached. Then the spring elements 22, 22′ are frictionally engaged with the slots 32, 32′ of the body 12 so that the fishing line is captured between the insulator 24 and the line guide 26. The operator then squeezes the quick release clip 46 to open the grip covered jaws 52, 52′ and threads a portion of the fishing line therebetween, thereafter releasing the clip 46 such that the selected portion of the fishing line is captured between the jaws 52, 52′.

Once placed in the water, and as illustrated in FIG. 4, the weight 64 tends to pull the one end of the body 12 downward, thus allowing the device 10 to dive to a selected depth when pulled or when a current is present. Once the bait is struck by a fish, the force of the striking causes a portion of the line 70 to be released from the grasp of the jaws 52, 52′ and the planing and diving motions are stopped. The device 10, however, remains securely attached to the line 70 by the line locking assembly 14, thus preventing its being lost. The device 10 is thus retrieved along with the line 70, the bait 72 and the fish (not illustrated).

The fishing device 10 allows a great deal of flexibility in use and in operation. Much of this versatility is the result of the pivoting movement of the arm 40 of the quick release assembly 16. Because of the presence of the ball 42 mounted within the ball receiver 58, the arm 40 is allowed to pivot, as illustrated in FIG. 7. According to this arrangement, a broad range of planing and diving maneuvers can be achieved through the manipulation of the fishing rod and reel.

As an alternative to diving, however, it may be desired for the fishing device 10 to be used for fishing on or near the surface. Accordingly, and with reference to FIG. 8, a float 74 may be releasably attached to the body 12 by frictional engagement or by fasteners in known manners.

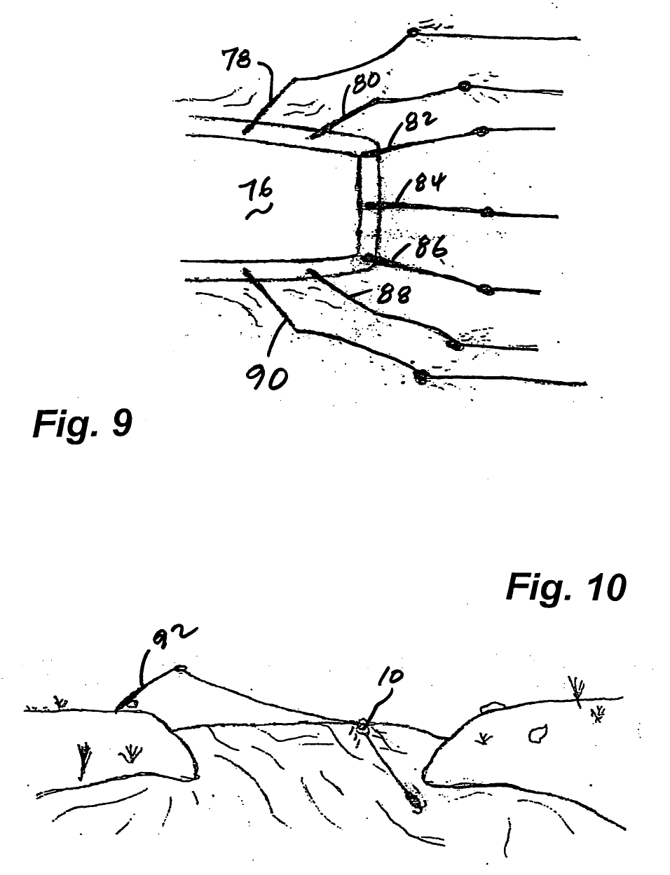

The fishing device 10 of the present invention may be used from a boat and may be used, as shown in FIG. 9, in conjunction with a plurality of similar devices from the same boat, illustrated generally as 76. As shown, a number of fishing rod and reel assemblies 78 through 90, each having a fishing device of the present invention (not visible) attached to a respective line are disposed at the stern of the boat 76 for trolling. As an alternative, the fishing device 10 of the present invention may be used from an on-shore position as shown in FIG. 10 where a lone fishing rod and reel 92 is being used in conjunction with a fishing device 10 for surface planing.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A diver for use with a fishing line having a fishing hook, the diver comprising:
a substantially planar, disk-shaped body, the body having a top side and a bottom side, said body including a ball receiver formed on said top side;
a line locking assembly for selectively securing a first portion of the fishing line to said body; and
a quick release assembly for releasably holding a second portion of the fishing line and for the quick release of the fishing line upon striking of the fishing hook by a fish, said quick release assembly including a ball and a shaft extending from said ball, said ball being pivotably within said ball receiver, said shaft extending through said body, the second portion of the fishing line being releasably attached to said shaft.

2. The diver of claim 1, wherein said body includes a side, said side having a notch defined therein, and wherein said line locking assembly further includes a locking member, said locking member being removably attached to said notch defined in said body.

3. The diver of claim 2, wherein said locking member is a spring.

4. The diver of claim 2, wherein said line locking assembly further includes a guide for holding the first portion of the line against said body, said guide being releasably attachable to said body.

5. The diver of claim 1, wherein said shaft of said quick release assembly includes a ball attachment end and a quick release clip end, said quick release assembly further including a quick release clip fitted to said quick release clip end of said shaft, said quick release clip being adjustably fitted to said shaft whereby said quick release clip may be adjusted in position along the length of said shaft to a position closer to or further from said ball.

6. The diver of claim 1, wherein said ball receiver includes a base integral with said top side of said body, said base having an aperture defined therethrough such that said aperture is defined through said body.

7. The diver of claim 1, further including a ball receiver cap fitted to said ball receiver.

8. The diver of claim 1, further including a counterweight, said counterweight being fitted to said body.

9. The diver of claim 1, further including a floatation device, said floatation device being fitted to said body.

10. A diver for use with a fishing line having a fishing hook, the diver comprising:
a substantially disk-shaped body, the body having a top side and a bottom side;
a line locking assembly for selectively securing a first portion of the fishing line to said body; and
a quick release assembly for releasably holding a second portion of the fishing line and for the quick release of the fishing line upon striking of the fishing hook by a fish, said quick release assembly including a pivoting element including an elongated portion, said elongated portion extending through said body, said quick release assembly further including a fishing line release portion attached to said elongated portion.

11. The diver of claim 10, wherein said pivoting element is a ball and wherein said elongated portion is a shaft, said shaft having a ball attachment end and a fishing line release portion end, said ball being attached to said ball attachment end and said fishing line release portion being attached to said fishing line release portion end.

12. The diver of claim 11, wherein said fishing line release portion is a quick release clip.

13. The diver of claim 11, wherein said ball is pivotable within said body includes a ball receiver formed on said top side, said ball of said quick-release assembly being pivotably situated within said ball receiver.

14. The diver of claim 13, wherein said ball receiver includes a base integral with said top side of said body, said base having an aperture defined therethrough such that said aperture is defined through said body.

15. The diver of claim 14, further including a ball receiver cap fitted to said ball receiver.

16. The diver of claim 10, further including a counterweight, said counterweight being fitted to said body.

17. The diver of claim 10, further including a floatation device, said floatation device being fitted to said body.

18. A diver for use with a fishing line having a fishing hook, the diver comprising:
a body having a top surface and a bottom surface, said top surface having a ball receiver and a line locking assembly receiver formed substantially thereupon;
a line locking assembly for selectively securing a first portion of the fishing line to said body; and
a quick release assembly for releasably holding a second portion of the fishing line and for the quick release of the fishing line upon striking of the fishing hook by a fish, said quick release assembly including a ball and a shaft extending from said ball, said ball being povotably disposed within said receiver, said quick release assembly including a quick release portion attached to said ball for releasably holding the second portion of the fishing line.

19. The diver of claim 18, wherein said quick release portion includes a shaft extending from said ball.

20. The diver of claim 20, further including a quick release clip attached to said shaft.
